(19) United States
(12) Patent Application Publication
(10) Pub. No.: US 2020/0212775 A1
(43) Pub. Date: Jul. 2, 2020

(54) Linear Vibration Motor

(71) Applicant: AAC Technologies Pte. Ltd., Singapore city (SG)

(72) Inventors: Yun Tang, Shenzhen (CN); Lubin Mao, Shenzhen (CN)

(21) Appl. No.: 16/705,266

(22) Filed: Dec. 6, 2019

(30) Foreign Application Priority Data
Dec. 27, 2018 (CN) 201822230055.8

(51) Int. Cl. H02K 33/10

(52) U.S. Cl. CPC H02K 33/10

(57) ABSTRACT

The present invention provides a linear vibration motor, including a base with an accommodating space, and a vibration unit located in the accommodating space. The vibration unit includes a weight, a containing groove, and a number of coil assemblies in the containing groove. The motor further includes a magnet at least partially accommodated in the containing groove and disposed opposite to the coil assembly, and an elastic piece for suspending the vibration unit. The coil assembly includes an iron core and a coil wound around the iron core. The magnet is magnetized along the vibrating direction, the coil assembly is magnetized along a direction perpendicular to the vibration direction, and the magnetic poles of the coil assembly adjacent to the magnet are the same and are disposed opposite to each other. By virtue of the configuration disclosed by the present invention, the vibration performance is improved.

### FIELD OF THE PRESENT DISCLOSURE

The present disclosure relates to the field of electrical transducers, more particularly to a linear vibration motor in a mobile device, for converting electrical signals into tactile feedbacks.

### DESCRIPTION OF RELATED ART

With the development of electronic technology, portable consumer electronic products, such as mobile phones, handheld game consoles, navigation devices or handheld multimedia entertainment devices are more and more popular. These electronic products generally use linear vibration motors to perform system feedback, such as phone call prompt, information prompt, navigation prompt, vibration feedback of game machines, etc. Such a wide range of applications requires that the vibration motor has excellent performance and long service life.

The linear vibration motor of the related technology comprises a base with a containing space, a vibration unit located in the containing space, an elastic piece for fixing the vibration unit and suspending the vibration unit in the containing space, and a coil fixed to the base. A magnetic field generated by electrification of the coil interacts with a magnetic field generated by the vibration unit to drive the vibration unit to do reciprocating rectilinear motion to generate vibration.

However, in the related linear vibration motor, the driving force of the vibration unit is only generated by a coil, that is, the vibration unit only vibrates in a driving mode by using Lorentz force, and the vibration effect is limited.

Therefore, it is necessary to provide a new linear vibration motor to solve the above technical problems.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an isometric view of a linear vibration motor in accordance with an exemplary embodiment of the present disclosure.

FIG. 2 is an exploded view of the linear vibration motor in FIG. 1.

FIG. 3 is a cross-sectional view of the linear vibration motor, taken along line A-A in FIG. 1.

FIG. 4 is a partially assembled view of the linear vibration motor in FIG. 2.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

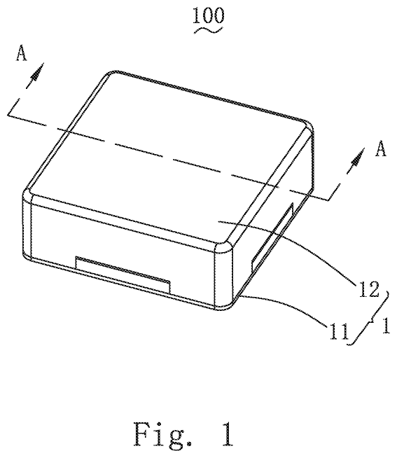

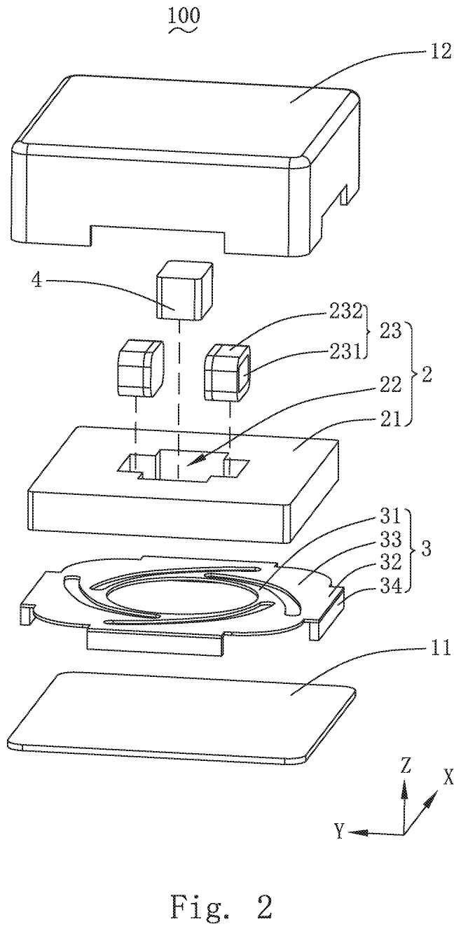

Referring to FIGS. 1-4, an exemplary embodiment of the present invention provides a linear vibration motor 100. The linear vibration motor 100 comprises a base 1, a vibration unit 2, an elastic piece 3 and a magnet 4.

The base 1 is provided with an accommodating space 10 for accommodating the vibration unit 2, the elastic piece 3 and the magnet 4 therein.

The base 1 comprises a base plate 11 and a cover plate 12 which engages with the base plate 11 for forming the accommodating space cooperatively.

The vibrating unit 2 is disposed in the accommodating space 10. The elastic piece 3 suspends the vibration unit 2 in the accommodating space and provides the vibration unit 2 with a vibration condition. The magnet 4 is fixed on the base 1 for driving the vibration unit 2 to vibrate.

In the embodiment, the elastic piece 3 is located on one side of the vibration unit 2 along a vibration direction and is connected with the vibration unit 2 to perform a z-axis direction vibration structure in the vertical direction.

Specifically, the vibrating unit 2 comprises a weight 21, a containing groove 22 penetrating the weight 21 along the vibrating direction of the vibrating unit 2, and at least one coil assembly 23 arranged in the containing groove 22 for being fixed to the weight 21. The coil assembly 23 is used for driving the vibration unit 2 to vibrate. The coil assembly 23 includes an iron core 231 fixed to the weight 21 and a coil 232 wound around the iron core 231. When an amount of the coil assembly 23 is two or more, the coil assemblies 23 are spaced from each other with a distance therebetween.

The amount of the coil assemblies 23 is not limited as described above. For example, in the embodiment, the amount of the coil assemblies 23 is two, and the two coil assemblies 23 are respectively fixed to the weight 21. The weight 21 is provided with a fixing groove 211 and a fixing platform 212. An amount of the fixing grooves 211 here is at least two, thus the two fixing grooves are respectively arranged corresponding to the two coil assemblies 23.

Further, the two fixing grooves 211 are formed by downward sinking relative to the two opposite sides of the containing groove 22.

The fixing platform 212 is formed by extending from one end, close to the elastic piece 3, of the weight 21 along a direction toward the elastic piece 3. The fixing platform 212 extends along a periphery of the containing groove 22, and the two coil assemblies 23 are respectively fixed in the two fixing grooves 211.

Further, in the present embodiment, the magnetized directions of the two coil assemblies 23 are both perpendicular to the vibration direction of the vibration unit 2 (Z-axis direction). In addition, the magnetic poles of the coil assembles 23 adjacent to the magnet 4 are disposed to be the same magnetic pole. Another word, the magnetic poles of the two coil assemblies 23 adjacent to the magnet are the same.

Further, a thickness of the coil assembly 23 is equal to a depth of the fixing groove 211, by which the coil assembly 23 will not occupy the space of the containing groove 22 after the coil assembly 23 is installed in the fixing groove 211, so that the magnet 4 can be designed to be larger and provide greater driving force. Accordingly, the vibration effect is improved.

The elastic piece 3 comprises a ring-shaped first fixing arm 31, a ring-shaped second fixing arm 32, a spring arm 33 connecting the first fixing arm 31 to the second fixing arm 32, and a reinforcing arm 34.

The first fixing arm 31 is arranged around the periphery of the containing groove 22 and is fixedly connected with the weight 21. Specifically, the first fixing arm 31 is sleeved on and fixed with the fixing platform 212, and meanwhile, the spring arm 33 is suspended by the first and second fixing arms.

The second fixing arm 32 is connected to the base 1, and the elastic arm 33 is suspended and is used for providing a vibration restoring force and a supporting force to the vibration unit 2.

The reinforcing arm 34 is formed by bending and extending from the periphery of the second fixing arm 32. The reinforcing arm 34 is fixedly connected with the base 1, and therefore the reliability of the first fixing arm 31 is improved.

The magnet 4 extends at least partially into the containing groove 22 and are spaced from the coil assembly 23.

In the embodiment, the magnet 4 is magnetized in the vibration direction (z-axis direction), and the magnetic pole of the magnet 4 in the containing groove 22 is same to or different from the magnetic pole of the iron core 231 adjacent to the magnet 4.

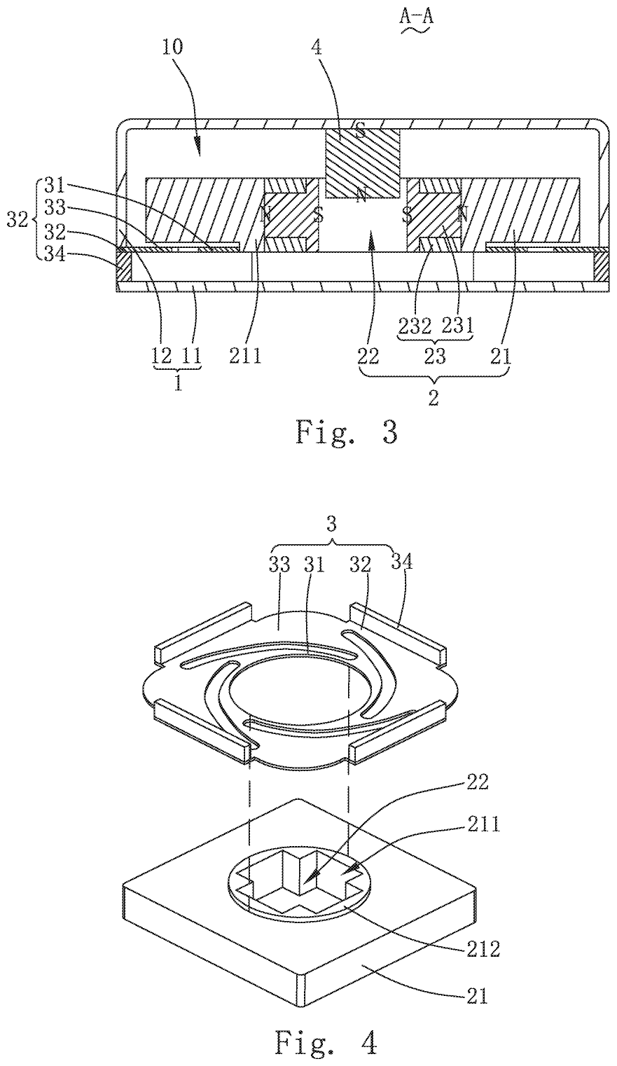

In the above-described structure, as further illustrated in FIG. 3, the magnetic pole of the magnet 4 in the containing groove 22 is N-pole, and the magnetic pole of the magnet 4 far away from the containing groove 22 is S-pole. When the iron cores 231 of the coil assemblies 23 are magnetized by the electrified coil 232, the two coils 232 produce magnetic fields with opposite directions, by which the magnetic poles of the iron cores 231 adjacent to the N-pole of the magnet 4 are disposed to be same. In the figure, the magnetic poles of the iron cores 231 adjacent to the N-pole of the magnet 4 are both S-poles, while the magnetic poles of the iron cores 231 far away from the N-pole of the magnet 4 are both N-poles. Thus, the S-poles of the iron cores and the N-pole of the magnet 4 produce attractive force, and the vibration unit 2 is forced to move upward by the iron cores 231 which are applied an upward force. When the coils 232 are electrified reversely, the iron cores are applied downward force and the vibration unit 2 is forced to move downward. At the same time, the coils 232 and the magnet 4 still cooperate with each other to produce Lorenz Force. By virtue of the combination of the Lorenz Force and the electromagnetic force, the vibration effect is improved, and the vibration performance of the linear vibration motor 100 is improved.

In order to further enhance the vibration effect of the vibration unit 2, the coil assembly includes four pieces respectively fixed with the weight. The four coil assemblies are uniformly spaced around the magnet. The containing groove is provided with a rectangular shape, and the four coil assemblies are disposed at four sides of the containing groove. The weight further includes four fixing grooves recessed outwardly along the four sides of the containing groove for positioning the four coil assemblies therein. By virtue of the four coil assemblies, the electromagnetic force and the Lorenz Force generated between the coil assemblies and the magnet are enhanced, thereby enhancing the driving effect and the vibration performance of the linear vibration motor.

Compared with the related technology, in the linear vibration motor of the invention, the magnetization direction of the magnet fixed on the base is perpendicular to the vibration direction, and the magnetization direction of the coil assemblies fixed on the vibration unit is perpendicular to the vibration direction. The magnetic poles of each coil assembly close to the magnet are the same. In the above structure, on one hand, the coil is electrified for generating a magnetic field, interacting with the magnet to generate a Lorentz force to drive the vibration unit. On the other hand, each coil is electrified to magnetize the iron core, and the magnetic poles on one side of each iron core close to the magnet are same to or different from the magnetic poles of the magnet in the containing groove, generating a force of mutual attraction or mutual repulsion, which is realized by changing the current direction of the coil. The driving mode of combining electromagnetic force and Lorentz force drives the vibration unit to vibrate, so that the vibration effect of the linear vibration motor is improved.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A linear vibration motor, comprising:
a base with an accommodating space;
a vibration unit located in the accommodating space, including a weight, a containing groove penetrating the weight along a vibration direction of the vibration unit, at least one pair of coil assemblies oppositely spaced from each other in the containing groove and respectively fixed to the weight;
a magnet fixed to the base for driving the vibration unit to vibrate, being at least partially accommodated in the containing groove and disposed opposite to the coil assembly;
an elastic piece for suspending the vibration unit in the accommodating space located on one side of the vibration unit along the vibration direction of the vibration unit; wherein
the coil assembly includes an iron core and a coil wound around the iron core, the magnet is magnetized along the vibrating direction, the coil assembly is magnetized along a direction perpendicular to the vibration direction, and the magnetic poles of the coil assembly adjacent to the magnet are the same and are disposed opposite to each other.

2. The linear vibration motor as described in claim 1, wherein the coil assembly further comprises four pieces respectively fixed to the weight, and the four coil assemblies are disposed uniformly around the magnet.

3. The linear vibration motor as described in claim 2, wherein the containing groove is in a shape of rectangular, and the four coil assemblies are disposed at four sides of the containing groove.

4. The linear vibration motor as described in claim 3, wherein the weight further comprises four fixing grooves recessed outwards from two opposite sides of the containing groove; each of the coil assembly is fixed in the corresponding fixing groove.

5. The linear vibration motor as described in claim 4, wherein a depth of the fixing groove is equal to a thickness of the coil assembly.

6. The linear vibration motor as described in claim 1, wherein the elastic piece comprises a ring-shaped first fixing arm, a ring-shaped second fixing arm and a spring arm connecting the first fixing arm to the second fixing arm; the first fixing arm is arranged around a periphery of the containing groove and is fixedly connected with the weight, the second fixing arm is connected to the base for suspending the spring arm.

7. The linear vibration motor as described in claim 6, wherein the elastic piece further comprises a reinforcing arm bending and extending from a periphery of the second fixing arm, and the reinforcing arm connects to the base.

8. The linear vibration motor as described in claim 6, wherein the weight includes a fixing platform protruding from one end thereof adjacent to the elastic piece toward the elastic piece, the fixing platform extends along the periphery of the containing groove, and the first fixing arm is sleeved on the fixing platform for fixing the first fixing arm.
